(19) United States
(12) Patent Application Publication
(10) Pub. No.: US 2016/0260091 A1
(43) Pub. Date: Sep. 8, 2016

(54) UNIVERSAL WALLET FOR DIGITAL CURRENCY

(71) Applicant: THC FARMACEUTICALS, INC., Scottsdale, AZ (US)

(72) Inventor: David Tobias, Mesquite, NV (US)

(73) Assignee: THC Farmaceuticals, Inc., Scottsdale, AZ (US)

(21) Appl. No.: 14/638,939

(22) Filed: Mar. 4, 2015

(51) Int. Cl. G06Q 20/36; H04L 9/08; G06Q 20/06

(52) U.S. Cl. CPC G06Q 20/3678; G06Q 20/0655; H04L 9/0838; G06Q 2220/00; H04L 2209/24

(57) ABSTRACT

A method for a crypto-coin wallet system has the steps of installing the wallet system on a local computer system to form an instance of a crypto-coin wallet, selecting a crypto-coin type to become a base currency, generating a unique wallet address that is permanently associated with the instance of the wallet, adding one or more crypto-coins to the wallet, wherein each crypto-coin has a unique address, and sending and receiving crypto-coins from a coin address of each coin to form a transaction. In an embodiment wallet addresses may be generated for more than one coin option, and wherein each crypto-coin has a single address. Sending or receiving a fraction of a crypto-coin may be final and irreversible. The method may have a step of backing up the wallet to form a backup, wherein a copy of the transaction is recorded to backed up files.

### CROSS-REFERENCE TO RELATED APPLICATION

Not applicable.

### BACKGROUND

1. Field of the Invention

This invention relates generally to digital currency wallets, and specifically to wallets that securely hold multiple digital currencies.

2. Description of Related Art

In traditional art, there are crypto currencies such as Bitcoin™ or Hempcoin™ (hereinafter “bitcoin” and “hempcoin”.) The crypto currencies are made up of coins that are created virtually, usually using algorithms that limit the creation of the coins. Crypto currencies are held in “wallets”, or virtual repositories, for their users.

In a transaction, a crypto currency is used to purchase goods or services. In the case of bitcoin or hempcoin, a crypto-coin may be purchased from a number of online exchanges for currency such as US dollars. The bitcoins or hempcoins purchased are held in a wallet, which functions like an online account. When purchasing a cup of coffee, for example, the wallet produces a QR code on the smartphone screen, which is scanned by a QR scanner in the coffee shop. The QR code allows the user's embedded secret password to unlock a bitcoin or hempcoin address and publicly informs the bitcoin or hempcoin computer network that a certain amount of bitcoin is being transferred from the user to the coffee shop. The transaction is immediately broadcast to the world, and the transaction is shared with bitcoin “miners” that maintain the system.

Typically, a wallet is required for each crypto currency. Therefore, a user who carries a number of different crypto currencies would require several wallets, which typically do not communicate with one another. Therefore, moving from once currency to another requires a virtual exchange, and cannot be performed within a single wallet.

In recent years, network-based wallets have been hacked and have proven insecure. It is as a result of the accessibility of the crypto coin wallets, as well as their insecure cryptographic algorithms that they have proven vulnerable to attack.

Therefore, there is a need for a crypto currency wallet that holds multiple currencies, that operates at a more secure level of encryption and avoids the dangers of a network-enabled wallet.

### SUMMARY OF THE INVENTION

A method for a crypto-coin wallet system has the steps of installing the wallet system on a local computer system to form an instance of a crypto-coin wallet, selecting a crypto-coin type to become a base currency, generating a unique wallet address that is permanently associated with the instance of the wallet, adding one or more crypto-coins to the wallet, wherein each crypto-coin has a unique address, and sending and receiving crypto-coins from a coin address of each coin to form a transaction.

In an embodiment wallet addresses may be generated for more than one coin option, and wherein each crypto-coin has a single address. Sending or receiving a fraction of a crypto-coin may be final and irreversible. The method may have a step of backing up the wallet to form a backup, wherein a copy of the transaction is recorded to backed up files, and wherein the user keeps the backup in isolation.

In an embodiment, in the transaction a buyer collects a seller's coin address and comprising the further step of the buyer entering the amount to pay and sending it to the seller. The method may have the further step of propagating the notice of currency transfer through the system.

In an embodiment, BIP38 is used for encryption and decryption of currency keys. It may have the further steps of computing the coin address (ASCII), and take the first four bytes of SHA256(SHA256( )) of it, to produce “addresshash”, deriving a key from a passphrase using a script, dividing the key in half, to produce derivedhalf1 and derivedhalf2, performing AES256Encrypt(block=bitcoinprivkey[0 . . . 15] xor derivedhalf1[0 . . . 15], key=derivedhalf2), calling the 16-byte result encryptedhalf1, and performing AES256Encrypt(block=bitcoinprivkey[16 . . . 31] xor derivedhalf1[16 . . . 31], key=derivedhalf2), calling the 16-byte result encryptedhalf2, wherein an encrypted private key is a Base58Check-encoded concatenation having 39 bytes without Base58 checksum: 0×01 0×42+flagbyte+salt+encryptedhalf1+encryptedhalf2.

In an embodiment the wallet uses an AES encrypted database to secure the wallet address and private key pairs. The steps may also be executed on a non-networked computer configured to provide physical security against unauthorized users. The steps may executed on a non-standard enterprise server having at least16 processor cores and a 500 GB maximum file size. In an embodiment, the method has the further step of uniquely identifying a user by a hardware chip component having a unique user key therein which identifies a user of a device to the wallet on that device. The hardware may be removable.

The foregoing, and other features and advantages of the invention, will be apparent from the following, more particular description of the preferred embodiments of the invention, the accompanying drawings, and the claims.

### BRIEF DESCRIPTION OF THE FIGURE

For a more complete understanding of the present invention, the objects and advantages thereof, reference is now made to the ensuing descriptions taken in connection with the accompanying drawings briefly described as follows:

FIG. 1 shows a flowchart displaying the operation of the multi-currency virtual wallet.

### DETAILED DESCRIPTION

The universal wallet is a universal wallet with one unified interface for every coin. All of the crypto coins held by a user may be stored in one location without the need to manage separate wallets for each coin. A user can only install one universal wallet on a device at a time, meaning that no device can have multiple universal wallets running at the same time. Nevertheless, a user can decide to have a universal wallet setup on each of his devices, although this may defeat the purpose of having all digital currencies stored in a single universal wallet location. Each coin has a secure digital key used to access the public coin addresses and sign transactions. The secure digital keys are kept in a universal wallet. The wallet relays transactions to the network, and enables a user to create coin addresses for sending and receiving virtual currency. Users are allowed to have only 1 public address per currency to receive coins, preventing multiple accounts per user and wherein a single wallet is linked to a single device. A single devices is interpreted by the system as a single user, although a single user may have multiple devices. The wallet is not mirrored between devices, however. The wallet performs as a conventional wallet, but virtually and able to hold multiple currencies. A single interface provides access to all coins.

In order to maintain the safety of the crypto-currency wallet, the algorithm is public and may be tested by the public and the industry. In one embodiment, the wallet is a universal QT wallet using a cross-platform application and UI framework for developers using C++ or QML, a CSS and JavaScript like language.

To install and use the wallet on a computer, the user first downloads an installer file, and runs the installer. The user then selects a crypto coin of his or her choice from the available options, to form the base currency. A unique wallet address is then generated, to be forever associated with that particular wallet, and the user may now receive and send coins from the coin address of each coin. A wallet address is a unique code that uniquely identifies each wallet. Both the coin and wallet have independent addresses. The wallet address is used for identifying the wallet on the network and for future generation of a “wallet key card” which functions like a token. A wallet key card for the universal wallet may have a QR code or smart chip and an internally concealed private key, and as a result the key card may be used as a conventional debit card is currently used wherever crypto coins are accepted. The coin address is needed for transactions, such as sending and receiving funds, for that particular coin. When a user sends a coin or a fraction of a coin to another user, the sender has a sending address (unique coin address) while the receiver also has a receiving address, in other words, a unique coin address for the receiver). If fractions of a coin are sent to two users, for example, both receivers will receive a notification in their wallets that they have received coins from the sender's unique address.

Users can select and generate wallet addresses for as many coin options as desired but each coin may only have one coin address.

What follows is a brief overview on how public and private keys are related to wallets, using bitcoin as example. A simple Bitcoin wallet consists on one of more pairs of public and private keys. Some wallet structures allow for deterministic public key generations and private keys that allow spending only part of the wallet. The “link” to Bitcoin initially happens during block generation where a certain amount of Bitcoin is generated and sent to the miner's public address; this is merely a record in the blockchain. Then these coins can also be sent to other public addresses using transactions.

The most basic transaction has one input and one output; i.e. it spends coins from one source address to one destination address. To be valid, the amount of output coins must not exceed the amount of input coins, and to be verified the output address hash is signed by the input address' private key.

In an embodiment, wallets balances become the sum of all inputs to that wallet, so when you make a transaction the software will select the desired number of inputs to get a sum equal or greater to the desired transaction output+fee. If the amount exceeds what you want to spend, the remainder can be send back to one of the input address or even a new address of your wallet, so you basically send yourself the exceeding amount of Bitcoins. Any unspent amount in the transaction is considered fee and is collected by the miner generating the block.

When a transaction is sent out, it is relayed to the network for inclusion in a block if it passes common rules for transactions (validity, fee, size, etc.). A miner will eventually pick the transaction and include it a block. In one embodiment, the transactions are actually included in a Merkle tree whose root hash is in in the block header, wherein the block header hash is the proof of work that has to match the difficulty requirement for the block.

All transactions are final and irreversible. Once a transaction succeeds, there are a number of system processes that write to system files. These files are responsible for maintaining the integrity of transactions and wallet status. Content of these files are not editable, and any attempt to forcefully edit the files will lead to corruption of the wallet and loss of funds.

Users can backup the entire wallet or schedule an auto backup option. The auto backup ensures that anytime a transaction is successful a copy of the transaction is safely written to the backed up files. Once a backup is made, it is the user's responsibility to periodically keep a copy of the backed up files in a safe location. The backup is not responsible for maintaining the current status of the wallet. It only keeps a copy of the critical files of the wallet, so it can produce them internally when needed.

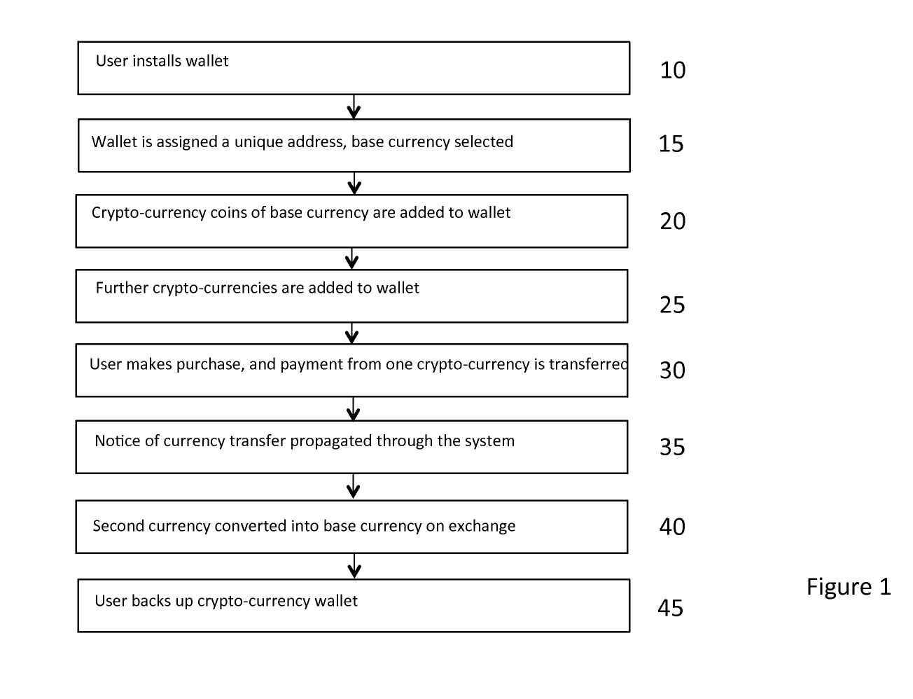

FIG. 1 shows the operation of the multi-currency wallet for crypto-currencies. In step 10, the user installs the wallet, and at step 15 the wallet is assigned a unique address. The user also selects the base currency of the multi-currency wallet. At step 20 crypto-currency coins, each having a unique address, are then added to the wallet. In Step 25, further currencies are added to the crypto-currency wallet, each currency adding a new wallet address, but only one wallet address per coin. At step 30 the user purchases a cup of coffee, and payment from one crypto-currency is transferred. The buyer collects the seller's coin address and enters it into the receiver's field on his wallet, and also enters the amount he intends to pay and send to the receiver. Immediately the seller receives a proof of transaction (an alert) that the funds have been received. At step 35, the notice of the currency transfer is propagated through the system. At step 40, a second currency is converted into the first currency on a crypto exchange site based on the current rate. At step 45, the user backs up the crypto-currency wallet to ensure that anytime a transaction is successful a copy of the transaction is safely written to the backed up files.

As for programming, this universal wallet may be written in Python in an embodiment. It may utilize BIP38 encryption and decryption for all currency keys. For example, a JavaScript component adheres to the BIP38 standard to secure the crypto currency private keys. Access to the wallet is highly secured by using private security keys, password and pass phrase. In an embodiment, the wallet utilizes AES encrypted SQLite database that secures user wallet address and private key pairs using BIP38.

Advanced Encryption Standard (AES256) and BIP38 are the generally accepted security standards for encrypting crypto coins. AES is the de facto standard for the US government and replaces DES used since 1977. In some embodiments AES256 provides excellent security, however a weakness is the key length, which, at 256 bits, is cumbersome.

AES256 also has known flaws. A related-key attack discovered by Alex Biryukov and Dmitry Khovratovich, which exploits AES's somewhat simple key schedule and has a complexity of 2^{99.5}. A further attack, by Alex Biryukov, Orr Dunkelman, Nathan Keller, Dmitry Khovratovich, and Adi Shamir, uses only two related keys and 2⁷⁰ time for an 11-round version. 256-bit AES uses 14 rounds, so these attacks aren't yet effective against full AES.

Like most ciphers, AES is vulnerable to side-channel attacks on specific implementations. Side-channel attacks do not attack the cipher itself, rather the implementation on various systems.

BIP38 encryption is a newer algorithm that addresses those flaws. In addition to providing all the security options offered by AES256, BIP38 offers some interoperability with the crypto currency eco-system. BIP38 has been used successfully for encrypting a wallet's private key to keep the balance safe (unless the passphrase is guessed). However, if the passphrase is lost the wallet cannot be recovered if encrypted with BIP38.

In BIP38, the encryption process is as follows: i) compute the coin address (ASCII), and take the first four bytes of SHA256(SHA256( ) of it, to produce “addresshash”; ii) derive a key from the passphrase using script; iii) the resulting 64 bytes are divided in half, to produce derivedhalf1 and derivedhalf2; iv) perform AES256Encrypt(block=bitcoinprivkey[0 . . . 15] xor derivedhalf1[0 . . . 15], key=derivedhalf2), call the 16-byte result encryptedhalf1; v) perform AES256Encrypt(block=bitcoinprivkey[16 . . . 31] xor derivedhalf1[16 . . . 31], key=derivedhalf2), call the 16-byte result encryptedhalf2. The encrypted private key is the Base58Check-encoded concatenation of the following, which totals 39 bytes without Base58 checksum: 0×01 0×42+flagbyte+salt+encryptedhalf1+encryptedhalf2.

The key is random binary data and the encrypted output is also binary data, resulting in an unwieldy key due to the degree of randomness of the binary data and the resultant encryption. In order to use a UNICODE or ASCII passphrase as the encryption key, a function such as PBKDF2 may be used. The output can be base64 encoded to make it ASCII so it can be printed/written, or may be kept in hex or binary formats.

As a result of the flexible implementation, the universal wallet will run on any Linux , Windows or Mac computer, or mobile device. In an embodiment, a feature of the wallet is that it runs on desktop computers that are non-networked (known as “cold-storage”) in order to provide a physical security against hackers and unauthorized users. The authorized user not only has the keys to operate the crypto-currency but possess the physical security and access for the desktop computer.

In a further embodiment, as a further safety measure a hardware chip component contains a unique user key which links a particular user of a device to the wallet on that device, and the hardware is removable by that person. The wallet may be connected to a unique hardware in order to be used for High end non-standard enterprise servers with features such as 16 processor cores, 64 GB main memory, with a 500 GB maximum file size may be used to increase the overall security and performance of the system.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for a crypto-coin wallet system, comprising the steps of:
a. installing the wallet system on a local computer system to form an instance of a crypto-coin wallet;
b. selecting a crypto-coin type to become a base currency;
c. generating a unique wallet address that is permanently associated with the instance of the wallet;
d. adding one or more crypto-coins to the wallet, wherein each crypto-coin has a unique address; and
e. sending and receiving crypto-coins from a coin address of each coin to form a transaction.

2. The method of claim 1 wherein wallet addresses may be generated for more than one coin option, and wherein each crypto-coin has a single address.

3. The method of claim 1, wherein sending or receiving a fraction of a crypto-coin is final and irreversible.

4. The method of claim 1 further comprising the step of backing up the wallet to form a backup, wherein a copy of the transaction is recorded to backed up files, and wherein the user keeps the backup in isolation.

5. The method of claim 1 wherein in the transaction a buyer collects a seller's coin address and comprising the further step of:
a. the buyer entering the amount to pay and sending it to the seller.

6. The method of claim 5 further comprising the step of propagating the notice of currency transfer through the system.

7. The method of claim 1 wherein BIP38 is used for encryption and decryption of currency keys.

8. The method of claim 7, further comprising the steps of:
a. computing the coin address (ASCII), and take the first four bytes of SHA256(SHA256( ) of it, to produce “addresshash”;
b. deriving a key from a passphrase using a script;
c. dividing the key in half, to produce derivedhalf1 and derivedhalf2;
d. performing AES256Encrypt(block=bitcoinprivkey[0 . . . 15] xor derivedhalf1[0 . . . 15], key=derivedhalf2), calling the 16-byte result encryptedhalf1; and
e. performing AES256Encrypt(block=bitcoinprivkey[16 . . . 31] xor derivedhalf1[16 . . . 31], key=derivedhalf2), calling the 16-byte result encryptedhalf2, wherein an encrypted private key is a Base58Check-encoded concatenation having 39 bytes without Base58 checksum: 0×01 0×42+flagbyte+salt+encryptedhalf1+encryptedhalf2.

9. The method of claim 1, wherein the wallet uses an AES encrypted database to secure the wallet address and private key pairs.

10. The method of claim 1, wherein the steps are executed on a non-networked computer configured to provide physical security against unauthorized users.

11. The method of claim 1, wherein the steps are executed on a non-standard enterprise server having at least 16 processor cores and a 500 GB maximum file size.

12. The method of claim 1, further comprising the step of uniquely identifying a user by a hardware chip component having a unique user key therein which identifies a user of a device to the wallet on that device.

13. The method of claim 12, wherein the hardware is removable.
